(19) United States
(12) Patent Application Publication
(10) Pub. No.: US 2023/0145100 A1
(43) Pub. Date: May 11, 2023

(54) VEHICLE AND CONTROL METHOD OF VEHICLE

(71) Applicant: TOYOTA JIDOSHA KABUSHIKI KAISHA, Toyota-shi (JP)

(72) Inventor: Yu NAGATA, Tokyo (JP)

(73) Assignee: TOYOTA JIDOSHA KABUSHIKI KAISHA, Toyota-shi (JP)

(21) Appl. No.: 17/940,675

(22) Filed: Sep. 8, 2022

(30) Foreign Application Priority Data
Nov. 11, 2021 (JP) 2021-183946

(51) Int. Cl. G06F 8/65; G06F 11/14

(52) U.S. Cl. CPC G06F 8/65; G06F 11/1464

(57) ABSTRACT

A vehicle includes: a plurality of control devices; and a DCM configured to wirelessly receive data from outside, the data being used to update programs stored in the control devices. A subsidiary ECU has a storage area in which a current program is stored. A master ECU has a free space in which the current program of the subsidiary ECU is storable. A central ECU controls an updating process of the programs in the master ECU and the subsidiary ECU. In a case where the current program of the subsidiary ECU is to be updated, the central ECU controls the master ECU and the subsidiary ECU such that, prior to the updating of the current program, the master ECU and the subsidiary ECU make a backup of the current program in the free space of the master ECU.

### CROSS-REFERENCE TO RELATED APPLICATION

This application claims priority to Japanese Patent Application No. 2021-183946 filed on Nov. 11, 2021, incorporated herein by reference in its entirety.

### BACKGROUND

### 1. Technical Field

This disclosure relates to a vehicle and a control method of a vehicle, and more particularly relates to a control technology to control a vehicle including a plurality of control devices.

### 2. Description of Related Art

An over-the-air (OTA) technology to update a program stored in an in-vehicle ECU by wireless communication has been studied and developed. For example, a control device described in WO 2019/187535 instructs an in-vehicle device to start an updating process of a program. Each in-vehicle device includes a first storage area in which a current version of the program is stored, and a second storage area in which the program is rewritable to a new version.

### SUMMARY

There is such a possibility that an updating process of a program might fail due to occurrence of voltage fluctuation or the like during execution of the updating process of the program. This might cause a vehicle not to work appropriately.

This disclosure is achieved in order to solve the problem, and an object of this disclosure is to prevent a situation that a vehicle does not work appropriately even when an updating process of a program fails.

(1) A vehicle according to one aspect of this disclosure includes a plurality of control devices and a communications device. The communications device is configured to wirelessly receive data from outside, the data being used to update programs stored in the control devices. The control devices include: a first control device having a storage area in which a current program is stored; a second control device having a free space in which the current program is storable, and a third control device configured to control an updating process of the programs in the first and second control devices. In a case where the current program stored in the storage area of the first control device is to be updated, the third control device controls the first and second control devices such that, prior to updating of the current program, the first and second control devices make a backup of the current program in the free space of the second control device.

(2) In a case where the third control device receives a notification indicating that the first control device has failed in updating of the current program, the third control device may control the first and second control devices such that the current program the backup of which is made in the second control device is recovered in the first control device.

(3) In a case where reset or voltage fluctuation occurs in the first control device during the updating of the current program in the first control device, the third control device may control the first and second control devices such that the current program the backup of which is made in the second control device is recovered in the first control device.

(4) In a case where the third control device does not receive, within a predetermined period of time, a notification indicating that the first control device has successfully updated the current program, the third control device may control the first and second control devices such that the current program the backup of which is made in the second control device is recovered in the first control device.

In the configuration of (1), prior to the updating of the current program, the backup of the current program is made in the free space of the second control device. Then, in a case where any of the conditions (2) to (4) is established, the current program thus backed up is recovered in the first control device. Accordingly, with the configuration of any of (1) to (4), even when the updating process of the program fails, it is possible to prevent such a situation that the vehicle does not work appropriately.

(5) In a case where the third control device receives a notification indicating that the first control device has successfully updated the current program, the third control device may control the second control device such that the second control device deletes the current program stored in the free space of the second control device.

In the configuration of (5), the current program stored in the free space of the second control device is deleted. Hereby, it is possible to prevent such a situation that the free space of the second control device becomes excessively small due to making a backup, thereby making it possible to secure a given free space in the second control device.

(6) A control method of a vehicle according to one aspect of this disclosure controls a vehicle configured to wirelessly receive data from outside, the data being used to update programs stored in a plurality of control devices. The control devices include a first control device having a storage area in which a current program is stored, and a second control device having a free space in which the current program is storable. The control method includes a step of, in a case where the current program stored in the storage area of the first control device is to be updated, making a backup of the current program in the free space of the second control device prior to updating of the current program.

With the method of (6), similarly to the configuration of (1), even when an updating process of the program fails, it is possible to prevent such a situation that the vehicle does not work appropriately.

With this disclosure, even when the updating process of the program fails, it is possible to prevent such a situation that the vehicle does not work appropriately.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a schematic configuration of an information processing system including a vehicle according to the present embodiment;

FIG. 2 is a block diagram illustrating a typical hardware configuration of the vehicle;

FIG. 3 is a block diagram illustrating a typical hardware configuration of ECUS;

FIG. 4 is a sequence diagram to describe the procedure of a process to be executed in a case where updating of a program in a subsidiary ECU is successful;

FIG. 5 is a first sequence diagram to describe the procedure of a process to be executed in a case where the updating of the program in the subsidiary ECU fails; and

FIG. 6 is a second sequence diagram to describe the procedure of a process to be executed in a case where the updating of the program in the subsidiary ECU fails.

### DETAILED DESCRIPTION OF EMBODIMENTS

The following describes an embodiment of this disclosure in detail with reference to the drawings. Note that the same or equivalent portions in the drawings have the same reference sign and redundant descriptions are not repeated.

### Embodiment

System Configuration

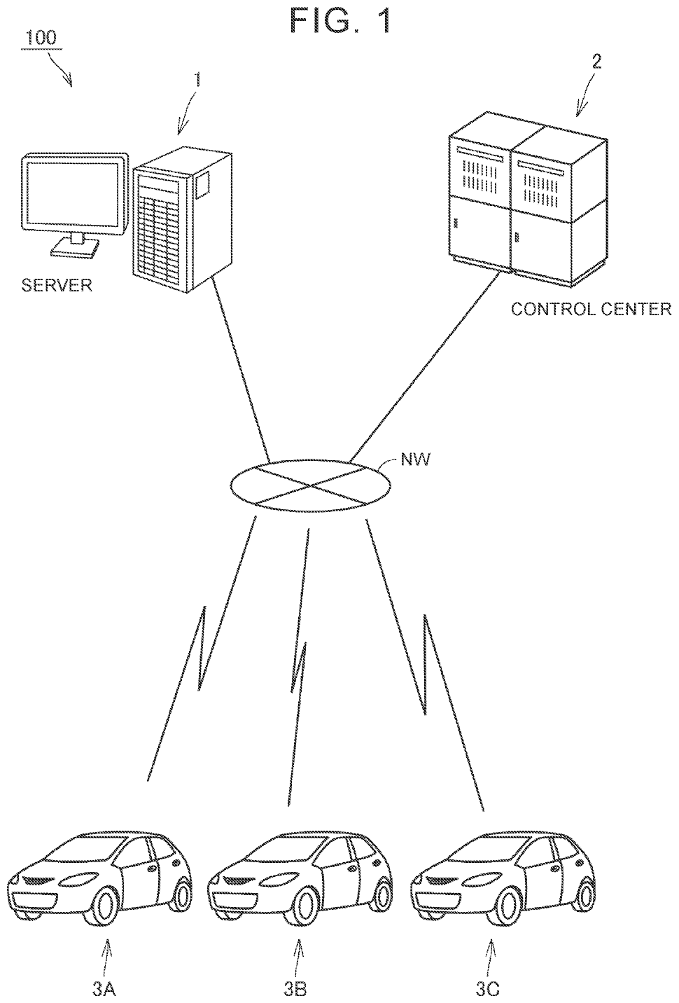

FIG. 1 is a view illustrating a schematic configuration of an information processing system including a vehicle according to the present embodiment. An information processing system 100 includes a server 1, a control center 2, and a plurality of vehicles 3A, 3B, 3C. In the following description, for purpose of this description, any one of the vehicles 3A, 3B, 3C is referred to as a vehicle 3. Note that three vehicles 3 are illustrated in FIG. 1, but the number of the vehicles 3 can be set to any number.

The server 1 is, for example, a company server of a company (a taxi company, a ride share service company, and the like) that manages the operation of the vehicles 3. The server 1 may be a shared server shared by a plurality of companies including the above company. The server 1 may be a cloud server provided by a cloud server management company.

The server 1 is used by an operation administrator of the vehicles 3. The operation administrator is, for example, a staff who works at a business unit managing the operation of the vehicles 3 and has authority to update programs of the vehicles 3.

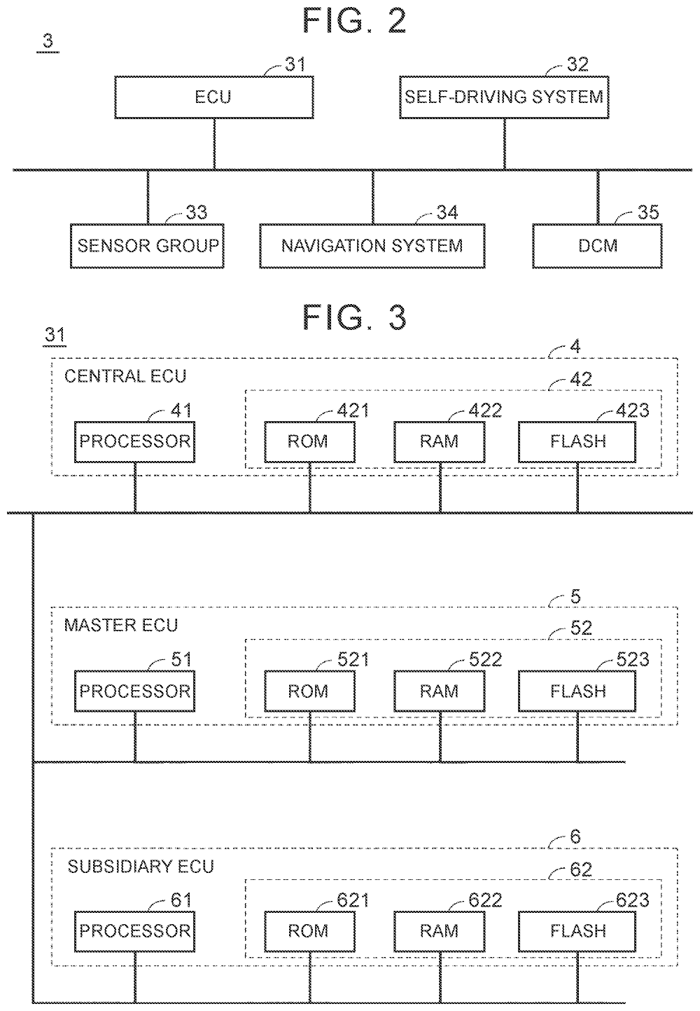

The control center 2 is a server of a company (e.g., a vehicle manufacturer) that provides a program for an electronic control unit (ECU) 31 provided in each of the vehicles 3 (see FIGS. 2, 3).

Each of the vehicles 3 is a self-driving vehicle, for example. Each of the vehicles 3 is used for the service provided by the company of the server 1. Types (vehicle types) of the vehicles 3 are selected appropriately depending on the service provided by the company. The server 1, the control center 2, and each of the vehicles 3 are connected to each other to be communicable with each other via a wired or wireless network NW.

Hardware Configuration of Vehicle

FIG. 2 is a block diagram illustrating a typical hardware configuration of the vehicle 3. The vehicle 3 includes an ECU 31, a self-driving system 32, a sensor group 33, a navigation system 34, and a data communication module (DCM) 35. The ECU 31, the self-driving system 32, the sensor group 33, the navigation system 34, and the DCM 35 are connected to each other via a wired in-vehicle network such as a controller area network (CAN) or Ethernet (registered trademark).

The self-driving system 32 is configured to execute self-driving of the vehicle 3. The self-driving is a control by which the operation of the vehicle 3 is executed without depending on a driving operation performed by a driver of the vehicle 3. In the present embodiment, the self-driving system 32 is configured to execute fully self-driving (unmanned operation) of the vehicle 3. However, the self-driving may include a control that supports the driving operation of the driver at the time of an operation of the vehicle 3 such as acceleration, deceleration, or steering of the vehicle 3. The self-driving system 32 may be part of the ECU 31. Note that the vehicle 3 as a fully self-driving vehicle is just an example, and the vehicle 3 may be a normal manned-operation vehicle.

The sensor group 33 includes a sensor configured to detect an external state around the vehicle 3 and sensors configured to detect information corresponding to a traveling state of the vehicle 3, a steering operation, an accelerator operation, and a brakes operation (any of them is not illustrated). More specifically, the sensor group 33 can include, for example, a camera, a radar, a laser imaging detection and ranging (LIDAR) sensor, a vehicle speed sensor, an acceleration sensor, and a yaw rate sensor (any of them is not illustrated).

The navigation system 34 includes a global positioning system (GPS) receiver (not illustrated). The GPS receiver specifies the position of the vehicle 3 based on radio waves from an artificial satellite (not illustrated). The navigation system 34 executes a navigation process for the vehicle 3 by use of position information on the vehicle 3 that is specified by the GPS receiver.

The DCM 35 is an in-vehicle communications module. The DCM 35 is configured to allow the ECU 31 and the server 1 to bidirectionally exchange data with each other and also allow the ECU 31 and the control center 2 to bidirectionally exchange data with each other. The DCM 35 corresponds to a “communications device” according to this disclosure.

The ECU 31 controls machinery so that the vehicle 3 is brought into a desired state in response to signals from the sensor group 33 and so on. The ECU 31 outputs a command to control various systems in collaboration with the self-driving system 32. Any of the various systems is not illustrated herein, but the various systems can include a braking system, a steering system, a power train system (e.g., an electric parking brake system, a parking lock system, a shifter, a motor generator), a body system (e.g., a direction indicator lamp, a horn, a wiper), and so on.

Further, the ECU 31 transmits various pieces of information indicative of the state of the vehicle 3 to the server 1 via the DCM 35 and also transmits various requests to the server 1 via the DCM 35. Further, the ECU 31 receives a command or a notification from the server 1 via the DCM 35. In addition, in the present embodiment, the ECU 31 receives (downloads) a program from the control center 2 via the DCM 35 and stores (installs) the downloaded program in a memory (described later) of the ECU 31 at an appropriate timing. Then, the ECU 31 activates the installed program at an appropriate timing.

Hardware Configuration of ECU

FIG. 3 is a block diagram illustrating a typical hardware configuration of the ECU 31. The ECU 31 includes a central ECU 4, a master ECU 5, and a subsidiary ECU 6. The central ECU 4, the master ECU 5, and the subsidiary ECU 6 are connected to each other via an in-vehicle network such as the CAN.

The central ECU 4 includes a processor 41 and a memory 42. The memory 42 includes a read only memory (ROM) 421, a random access memory (RAM) 422, and a flash memory 423. The master ECU 5 includes a processor 51 and a memory 52. The memory 52 includes a ROM 521, a RAM 522, and a flash memory 523. The subsidiary ECU 6 includes a processor 61 and a memory 62. The memory 62 includes a ROM 621, a RAM 622, and a flash memory 623.

In the memory 62 of the subsidiary ECU 6, software to be executed by the processor 61 of the subsidiary ECU 6 is stored. Particularly, the flash memory 623 has a storage area in which a current program updatable by OTA is stored, and a free space.

Similarly, in the memory 52 of the master ECU 5, software to be executed by the processor 51 of the master ECU 5 is stored. The flash memory 523 has a storage area in which a current program updatable by OTA is stored, and a free space. In the present embodiment, the free space of the flash memory 523 of the master ECU 5 is larger than the free space of the flash memory 623 of the subsidiary ECU 6.

The processor 41 of the central ECU 4 controls an updating process of programs in the master ECU 5 and the subsidiary ECU 6.

Note that the subsidiary ECU 6 corresponds to a “first control device” in this disclosure. The master ECU 5 corresponds to a “second control device” in this disclosure. The central ECU 4 corresponds to a “third control device” in this disclosure. The flash memories 423, 523, 623 may be other rewritable nonvolatile memories.

Failure in Updating of Program

In a case where voltage fluctuation or the like occurs in the subsidiary ECU 6 during execution of the updating process (OTA) of a program in the subsidiary ECU 6, the updating process of the program might fail. The free space of the flash memory 623 of the subsidiary ECU 6 is relatively small and is not so large that a new program cannot be stored while a current program is maintained. Accordingly, in a case where the program in the subsidiary ECU 6 is to be updated, the current program is sequentially rewritten to the new program during execution of the updating process. In this case, when the updating process fails, the current program cannot be recovered because the current program has been already partially or fully deleted. As a result, the vehicle 3 might not work appropriately.

In view of this, in the present embodiment, prior to the execution of the updating process of the program, the current program in the subsidiary ECU 6 is copied in the free space of the flash memory 523 of the master ECU 5. In other words, a backup of the current program in the subsidiary ECU 6 is made in the flash memory 523 of the master ECU 5. This is because the free space of the flash memory 523 of the master ECU 5 is larger than the free space of the flash memory 623 of the subsidiary ECU 6, and the backup of the current program in the subsidiary ECU 6 can be made in the free space of the flash memory 523. Hereby, even in a case where the updating process fails, when the backup of the current program is transmitted from the master ECU 5 to the subsidiary ECU 6, the subsidiary ECU 6 can recover the current program. As a result, it is possible to prevent such a situation that the vehicle 3 does not work appropriately.

Note that the condition that the free space of the flash memory 623 of the subsidiary ECU 6 is so small that a new program cannot be stored therein is not essential. Regardless of the capacity of the free space of the flash memory 623, the backup of the current program in the subsidiary ECU 6 may be made in the flash memory 523 of the master ECU 5.

Processing Sequence

With reference to sequence diagrams, the following describes details of a process to be executed in a case where the program in the subsidiary ECU 6 by the OTA is successfully updated and a process to be executed in a case where the program in the subsidiary ECU 6 by the OTA fails in updating.

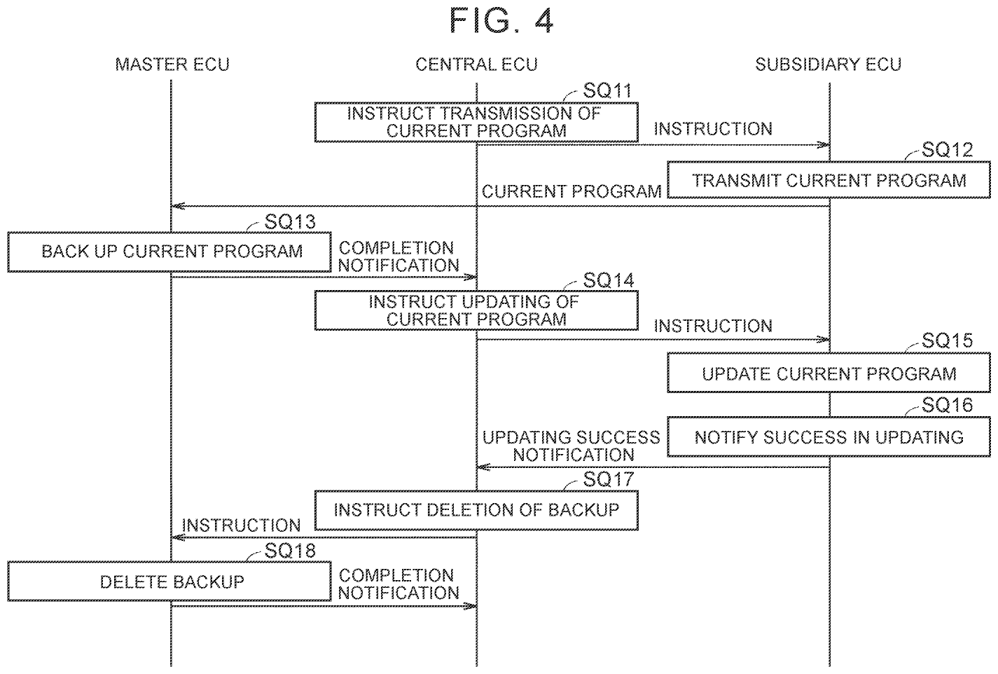

FIG. 4 is a sequence diagram to describe the procedure of a process to be executed in a case where the program in the subsidiary ECU 6 is updated successfully. In the drawing, a process to be executed by the master ECU 5 (the processor 51 and the memory 52) is illustrated on the left side, a process to be executed by the central ECU 4 (the processor 41 and the memory 42) is illustrated in the center, and a process to be executed by the subsidiary ECU 6 (the processor 61 and the memory 62) is illustrated on the right side. Each process is implemented by a software process to be executed by a corresponding ECU but may be implemented by hardware (an electric circuit) placed in the ECU. Hereinafter, a sequence is referred to as “SQ.”

The central ECU 4 grasps the free space of the flash memory 623 of the subsidiary ECU 6 and also grasps the free space of the flash memory 523 of the master ECU 5. Further, the central ECU 4 acquires, from the control center 2, the size of a new program for the subsidiary ECU 6 that is to be downloaded. For example, in a case where the size of the new program is larger than the free space of the flash memory 623 of the subsidiary ECU 6 and the size of the program is smaller than the free space of the flash memory 523 of the master ECU 5, the central ECU 4 can execute the following process.

In SQ11, the central ECU 4 instructs the subsidiary ECU 6 to transmit the current program from the subsidiary ECU 6 to the master ECU 5. Upon receipt of the instruction from the central ECU 4, the subsidiary ECU 6 transmits the current program to the master ECU 5 (SQ12). The master ECU 5 makes a backup of the current program received from the subsidiary ECU 6 in the flash memory 523 (SQ13). When the backup process is completed, the master ECU 5 notifies the central ECU 4 of the completion of the backup process.

In SQ14, the central ECU 4 instructs the subsidiary ECU to update the current program. Upon receipt of the instruction from the central ECU 4, the subsidiary ECU 6 updates the current program (SQ15). That is, the subsidiary ECU 6 rewrites the current program stored in the flash memory 623 by the new program received from the control center 2 (the subsidiary ECU 6 installs the new program). Then, the subsidiary ECU 6 activates the installed new program at an appropriate timing.

In the example illustrated in FIG. 4, the current program is successfully updated. The subsidiary ECU 6 notifies the central ECU 4 that the current program has been successfully updated (SQ16). Upon receipt of the updating success notification from the subsidiary ECU 6, the central ECU 4 instructs the master ECU 5 to delete the backup made in the flash memory 523 of the master ECU 5 in SQ13 (SQ17). The master ECU 5 deletes the backup in accordance with the instruction from the central ECU 4 (SQ18). When the deletion of the backup is completed, the master ECU 5 notifies the central ECU 4 of the completion of the deletion of the backup.

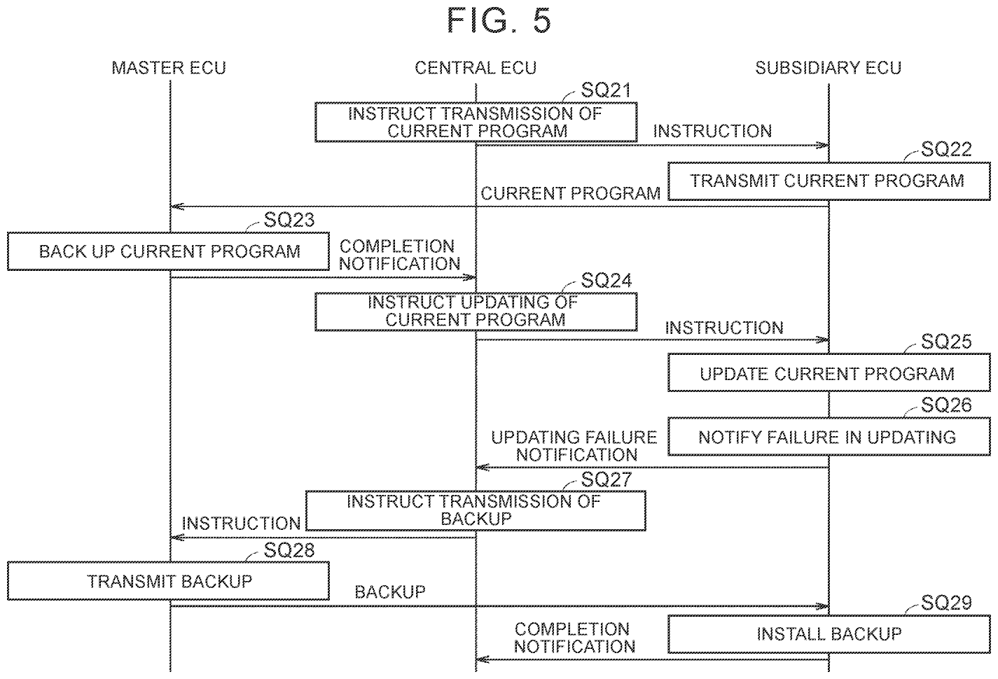

FIG. 5 is a first sequence diagram to describe the procedure of a process to be executed in a case where the program in the subsidiary ECU 6 fails in updating. The processes of SQ21 to SQ25 are similar to the processes of SQ11 to SQ15 in FIG. 4, and therefore, descriptions thereof are not repeated.

In the example illustrated in FIG. 5, the current program fails in updating. The subsidiary ECU 6 notifies the central ECU 4 that the current program has failed in updating (SQ26). Upon receipt of the updating failure notification from the subsidiary ECU 6, the central ECU 4 instructs the master ECU 5 to transmit, to the subsidiary ECU 6, the backup made in the flash memory 523 of the master ECU 5 in SQ23 (SQ27). The master ECU 5 transmits, to the subsidiary ECU 6, the backup in accordance with the instruction from the central ECU 4 (SQ28). The subsidiary ECU 6 rewrites the new program for updating by the backup received from the master ECU 5. That is, the subsidiary ECU 6 recovers (installs) the backup instead of the new program that has failed in updating (SQ29). When the backup has been recovered, the subsidiary ECU 6 notifies the central ECU 4 of the completion of the recovery of the backup.

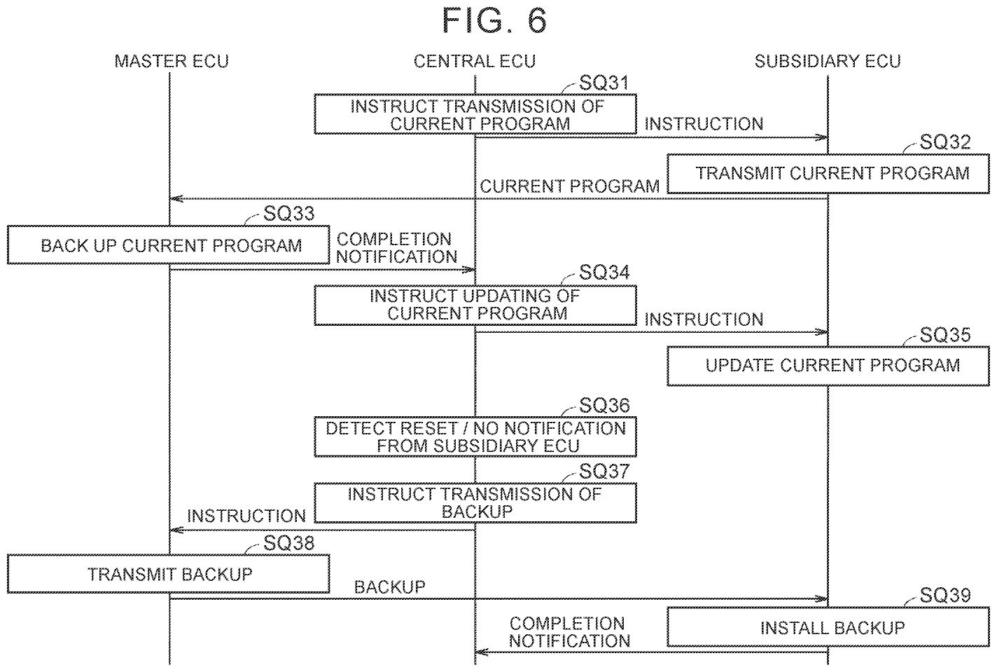

FIG. 6 is a second sequence diagram to describe the procedure of a process to be executed in a case where the program in the subsidiary ECU 6 fails in updating. Since the processes of SQ31 to SQ35 are similar to the processes of SQ11 to SQ15 (see FIG. 4) or the processes of SQ21 to SQ25 (see FIG. 5), descriptions thereof are not repeated.

In the example illustrated in FIG. 6, the current program fails in updating. However, this example is different from the example illustrated in FIG. 5 in that the subsidiary ECU 6 does not notify the central ECU 4 that the current program has failed in updating. The central ECU 4 detects the occurrence of reset or voltage fluctuation in the subsidiary ECU 6 during updating of the program (that is, before the central ECU 4 receives an updating success notification from the subsidiary ECU 6). Alternatively, the central ECU 4 detects a lapse of a predetermined period of time without receiving an updating failure notification (or an updating success notification) from the subsidiary ECU 6 after the central ECU 4 instructs updating of the current program. In such a case, even when the central ECU 4 is not notified of an updating failure by the subsidiary ECU 6, the central ECU 4 can determine that the subsidiary ECU 6 fails in updating of the current program.

When the central ECU 4 determines that the subsidiary ECU 6 has failed in updating of the current program, the central ECU 4 instructs the master ECU 5 to transmit, to the subsidiary ECU 6, the backup made in the flash memory 523 of the master ECU 5 (SQ37). Since the processes of SQ38, SQ39 after that are similar to the processes of SQ28, SQ29 (see FIG. 5), descriptions thereof are not repeated.

Thus, in the present embodiment, for example, in a case where the new program in the subsidiary ECU 6 that is to be downloaded by the OTA cannot be installed in the free space of the flash memory 623 of the subsidiary ECU 6 (that is, in a case where the current program should be deleted at the same time as the new program is installed), the central ECU 4 instructs the master ECU 5 and the subsidiary ECU 6 to make a backup of the current program in the subsidiary ECU 6. Since the backup of the current program in the subsidiary ECU 6 is made in advance, even when the current program fails in updating, the current program thus backed up can be recovered in the subsidiary ECU 6. Accordingly, with the present embodiment, it is possible to prevent such a situation that the vehicle 3 does not work appropriately even when the updating process of the program in the subsidiary ECU 6 fails.

It should be considered that the embodiment described herein is just an example in all respects and is not limitative. The scope of this disclosure is shown by Claims, not by the descriptions of the above embodiment, and is intended to include every modification made within the meaning and scope equivalent to Claims.

What is claimed is:

1. A vehicle comprising:
a plurality of control devices; and
a communications device configured to wirelessly receive data from outside, the data being used to update programs stored in the control devices, wherein:
the control devices include
a first control device having a storage area in which a current program is stored,
a second control device having a free space in which the current program is storable, and
a third control device configured to control an updating process of the programs in the first and second control devices; and
in a case where the current program stored in the storage area of the first control device is to be updated, the third control device controls the first and second control devices such that, prior to updating of the current program, the first and second control devices make a backup of the current program in the free space of the second control device.

2. The vehicle according to claim 1, wherein, in a case where the third control device receives a notification indicating that the first control device has failed in updating of the current program, the third control device controls the first and second control devices such that the current program the backup of which is made in the second control device is recovered in the first control device.

3. The vehicle according to claim 1, wherein, in a case where reset or voltage fluctuation occurs in the first control device during the updating of the current program in the first control device, the third control device controls the first and second control devices such that the current program the backup of which is made in the second control device is recovered in the first control device.

4. The vehicle according to claim 1, wherein, in a case where the third control device does not receive, within a predetermined period of time, a notification indicating that the first control device has successfully updated the current program, the third control device controls the first and second control devices such that the current program the backup of which is made in the second control device is recovered in the first control device.

5. The vehicle according to claim 1, wherein, in a case where the third control device receives a notification indicating that the first control device has successfully updated the current program, the third control device controls the second control device such that the second control device deletes the current program stored in the free space of the second control device.

6. A control method of a vehicle configured to wirelessly receive data from outside, the data being used to update programs stored in a plurality of control devices, the control devices including
a first control device having a storage area in which a current program is stored, and
a second control device having a free space in which the current program is storable, the control method comprising a step of, in a case where the current program stored in the storage area of the first control device is to be updated, making a backup of the current program in the free space of the second control device prior to updating of the current program.
